(19) United States
(12) Patent Application Publication
(10) Pub. No.: US 2024/0325957 A1
(43) Pub. Date: Oct. 3, 2024

(54) PILLAR-SHAPED HONEYCOMB STRUCTURE FILTER AND METHOD FOR MANUFACTURING SAME

(71) Applicant: NGK INSULATORS, LTD., Nagoya-City (JP)

(72) Inventors: Daiki TAKATA, Nagoya-Shi (JP); Yusuke TSUCHIYA, Nagoya-Shi (JP); Shungo NAGAI, Nagoya-Shi (JP)

(73) Assignee: NGK INSULATORS, LTD., Nagoya-City (JP)

(21) Appl. No.: 18/609,308

(22) Filed: Mar. 19, 2024

(30) Foreign Application Priority Data
Mar. 30, 2023 (JP) 2023-056773

(51) Int. Cl. B01D 46/24; B01D 39/20; B01D 46/00

(52) U.S. Cl. CPC B01D 46/2496; B01D 39/2068; B01D 46/0001; B01D 46/2482; B01D 46/2484

(57) ABSTRACT

A pillar-shaped honeycomb structure filter, comprising a plurality of first cells extending from an inlet side end surface to an outlet side end surface, opening on the inlet side end surface and having a sealing portion on the outlet side end surface; and a plurality of second cells extending from the inlet side end surface to the outlet side end surface, having a sealing portion on the inlet side end surface and opening on the outlet side end surface, the plurality of first cells and the plurality of second cells alternately arranged adjacent to each other with a porous partition wall interposed therebetween; wherein a porous film composed of a plurality of particles is formed on a surface of each of the first cells, and the interparticle distance for the plurality of particles at which a cumulative ratio is 90% (D90) is 12.0 μm or less.

### CROSS REFERENCE TO RELATED APPLICATIONS

The present invention claims the benefit of priority to Japanese Patent Application No. 2023-056773 filed on Mar. 30, 2023 with the Japanese Patent Office, the entire contents of which are incorporated herein by reference in its entirety.

### FIELD OF THE INVENTION

The present invention relates to a pillar-shaped honeycomb structure filter. The present invention also relates to a method of manufacturing a pillar-shaped honeycomb structure filter.

### BACKGROUND OF THE INVENTION

Exhaust gas discharged from internal combustion engines such as diesel engines and gasoline engines contains particulate matter (hereinafter referred to as PM) such as soot. Soot is harmful to the human body and its emission is regulated. Currently, in order to comply with exhaust gas regulations, filters typified by DPF and GPF are widely used, which filter PM such as soot by passing exhaust gas through permeable partition walls with small-pore.

As a filter for collecting PM, there is known a wall flow type pillar-shaped honeycomb structure body, comprising a plurality of first cells extending in the height direction from the inlet side end surface to the outlet side end surface, opening on the inlet side end surface and having a sealing portion on the outlet side end surface; and a plurality of second cells extending in the height direction from the inlet side end surface to the outlet side end surface, having a sealing portion on the inlet side end surface and opening on the outlet side end surface, the second cells arranged adjacent to the first cell with a partition wall interposed therebetween.

In recent years, with the tightening of exhaust gas regulations, stricter PM emission standards (PN regulations: particle matter number regulations) have been introduced, and filters are required to have high PM collection performance (PN high collection efficiency). Accordingly, it has been proposed to form a layer for collecting PM (hereinafter also referred to as a “porous film” or collecting layer”) on the surface of the cells (Patent Literature 1 to 3). By forming a porous film, PM can be collected while reducing pressure loss. A known method for forming a porous film comprises supplying an aerosol containing ceramic particles toward the inlet side end surface of a pillar-shaped honeycomb structure body to make the aerosol adhere to the surface of the first cell, and then performing a heat treatment.

### PRIOR ART

### Patent Literature

[Patent Literature 1] Japanese Patent Application Publication No. 2021-154272
[Patent Literature 2] Japanese Patent Application Publication No. 2021-154274
[Patent Literature 3] Japanese Patent Application Publication No. 2022-157612

### SUMMARY OF THE INVENTION

Forming a porous film on the surface of the cells is considered to be effective in improving the PM collection performance of the pillar-shaped honeycomb structure filter. However, although various methods for manufacturing porous film have been studied in the past, the influence of the structure of the porous film itself on PM collection performance has not been elucidated. For example, until now, it has only been confirmed that the thickness of a porous film and the particle diameter of raw material particles before film formation treatment have an effect on PM collection performance. Although Patent Literature 3 mentions the average pore diameter of the porous film, there remains room for improving the PM collection performance.

In view of the above circumstances, in one embodiment, an object of the present invention is to provide a pillar-shaped honeycomb structure filter with improved PM collection performance. In another embodiment, another object of the present invention is to provide a method for manufacturing such a pillar-shaped honeycomb structure filter.

The inventors of the present invention made extensive studies to solve the above problems, and found that the interparticle distance contained in a porous film is closely related to PM collection performance, and controlling the interparticle distance at which the cumulative ratio is 90% (D90) is particularly effective in improving PM collection performance. The present invention was completed based on this finding, and is exemplified as below.

### [Aspect 1]

A pillar-shaped honeycomb structure filter, comprising a plurality of first cells extending from an inlet side end surface to an outlet side end surface, opening on the inlet side end surface and having a sealing portion on the outlet side end surface; and a plurality of second cells extending from the inlet side end surface to the outlet side end surface, having a sealing portion on the inlet side end surface and opening on the outlet side end surface, the plurality of first cells and the plurality of second cells alternately arranged adjacent to each other with a porous partition wall interposed therebetween;
wherein a porous film composed of a plurality of particles is formed on a surface of each of the first cells, and
when observing the porous film in a cross-section parallel to a film thickness direction, and measuring an interparticle distance for the plurality of particles, which is a distance between adjacent particles in a direction perpendicular to the film thickness direction to determine a frequency distribution of the interparticle distance, the interparticle distance at which a cumulative ratio is 90% (D90) is 12.0 μm or less.

### [Aspect 2]

The pillar-shaped honeycomb structure filter according to aspect 1, wherein the interparticle distance (D90) at which the cumulative ratio is 90% is 11.0 μm or less.

### [Aspect 3]

The pillar-shaped honeycomb structure filter according to aspect 1 or 2, wherein when observing the porous film in the cross-section parallel to the film thickness direction, and measuring the interparticle distance for the plurality of particles, which is the distance between adjacent particles in the direction perpendicular to the film thickness direction to determine the frequency distribution of the interparticle distance, an average value of the interparticle distance is 5.3 μm or less.

### [Aspect 4]

The pillar-shaped honeycomb structure filter according to aspect 3, wherein the average value of the interparticle distance is 5.0 μm or less.

### [Aspect 5]

The pillar-shaped honeycomb structure filter according to aspects 1 to 4, wherein when observing the porous film in the cross-section parallel to the film thickness direction, and measuring the interparticle distance for the plurality of particles, which is the distance between adjacent particles in the direction perpendicular to the film thickness direction to determine the frequency distribution of the interparticle distance, a standard deviation of the interparticle distance is 3.6 μm or less.

### [Aspect 6]

The pillar-shaped honeycomb structure filter according to aspect 5, wherein the standard deviation of the interparticle distance is 3.4 μm or less.

### [Aspect 7]

The pillar-shaped honeycomb structure filter according to aspects 1 to 6, wherein the porous film has an average thickness of 2 to 40 μm.

### [Aspect 8]

The pillar-shaped honeycomb structure filter according to any one of aspects 1 to 7, wherein a main component of the porous film is silicon carbide, alumina, silica, cordierite, or mullite.

### [Aspect 9]

A method for manufacturing a pillar-shaped honeycomb structure filter, comprising:
preparing a pillar-shaped honeycomb structure body, comprising a plurality of first cells extending from an inlet side end surface to an outlet side end surface, opening on the inlet side end surface and having a sealing portion on the outlet side end surface; and a plurality of second cells extending from the inlet side end surface to the outlet side end surface, having a sealing portion on the inlet side end surface and opening on the outlet side end surface, the plurality of first cells and the plurality of second cells alternately arranged adjacent to each other with a porous partition wall interposed therebetween;
adhering ceramic particles to a surface of the first cells by injecting an aerosol containing ceramic particles from a nozzle of an aerosol generator toward the inlet side end surface from a direction perpendicular to the inlet side end surface, while applying a suction force to the outlet side end surface to suck the injected aerosol from the inlet side end surface; and
performing a baking treatment on the ceramic particles adhered to the surface of the first cells to generate a porous film composed of a plurality of particles on the surface of the first cells;
wherein the aerosol generator has an accommodating section that accommodates the ceramic particles having a BET specific surface area of 3.5 m²/g or more, and the ceramic particles are configured to be supplied from the accommodating section to the nozzle.

### [Aspect 10]

The method for manufacturing a pillar-shaped honeycomb structure filter according to claim 9, wherein the accommodating section accommodates the ceramic particles having a BET specific surface area of 4.0 m²/g or more.

### [Aspect 11]

The method for manufacturing a pillar-shaped honeycomb structure filter according to aspect 9 or 10, wherein the aerosol generator comprises a driving gas flow path for flowing pressurized driving gas; a supply port provided on the way of the driving gas flow path and capable of sucking the ceramic particles from the accommodating section, from an outer peripheral side of the driving gas flow path into the driving gas flow path; and the nozzle that is attached to a tip of the driving gas flow path and is capable of injecting the aerosol.

### [Aspect 12]

The method for manufacturing a pillar-shaped honeycomb structure filter according to any one of aspects 9 to 11, wherein the accommodation section accommodates the ceramic particles having a median diameter (D50) of 0.5 to 3.0 μm in a volume-based cumulative particle diameter distribution measured by a laser diffraction/scattering method.

### [Aspect 13]

The method for manufacturing a pillar-shaped honeycomb structure filter according to any one of aspects 9 to 12, wherein the baking treatment comprises holding the pillar-shaped honeycomb structure body having the ceramic particles adhered to the surface of the first cells in a heating furnace with an internal furnace atmosphere temperature of 1100 to 1300° C. for 1.5 to 4 hours.

According to the pillar-shaped honeycomb structure filter according to one embodiment of the present invention, it is possible to provide a pillar-shaped honeycomb structure filter with improved PM collection performance. In addition, since the relationship between the interparticle distance contained in the porous film of a pillar-shaped honeycomb structure filter and PM collection performance has been unveiled, by using this relationship as the basis for performance evaluation, it is also possible to accelerate the development speed of pillar-shaped honeycomb structure filters.

### BRIEF DESCRIPTION OF THE DRAWINGS

FIG. 1 is a perspective view schematically showing an example of a pillar-shaped honeycomb structure filter.

FIG. 2 is a schematic cross-sectional view of an example of a pillar-shaped honeycomb structure filter viewed from a cross-section parallel to the direction in which the cells extend.

FIG. 3 is a schematic partial enlarged view of a pillar-shaped honeycomb structure filter viewed from a cross-section perpendicular to the direction in which the cells extend.

FIG. 4 is a diagram schematically showing a structural example of an aerosol generator.

FIG. 5 is a schematic diagram for explaining a configuration example of a particle adhesion device.

FIG. 6 is an example of a SEM image when a porous film is observed in a cross-section parallel to the film thickness direction.

FIG. 7 is a graph showing the relationship between interparticle distance (D90) and collection performance.

FIG. 8 is a schematic diagram of a cross-section of a pillar-shaped honeycomb structure filter cut out to determine the average thickness of a porous film.

### DETAILED DESCRIPTION OF THE INVENTION

Hereinafter, embodiments of the present invention will now be described in detail with reference to the drawings. It should be understood that the present invention is not intended to be limited to the following embodiments, and any change, improvement or the like of the design may be appropriately added based on ordinary knowledge of those skilled in the art without departing from the spirit of the present invention.

### <1. Pillar-Shaped Honeycomb Structure Filter>

A pillar-shaped honeycomb structure filter according to an embodiment of the present invention will be described. The pillar-shaped honeycomb structure filter can be used as a DPF (Diesel Particulate Filter) and a GPF (Gasoline Particulate Filter) that are installed in the exhaust gas line from a combustion device, typically an engine installed in a vehicle, to collect soot. The pillar-shaped honeycomb structure filter according to the present invention can be installed, for example, in an exhaust pipe.

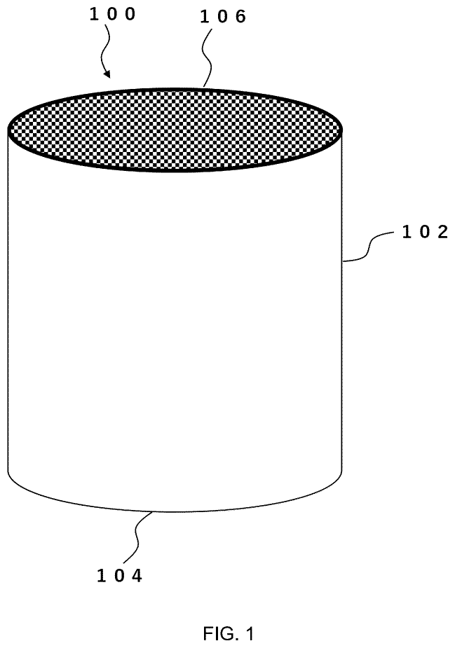

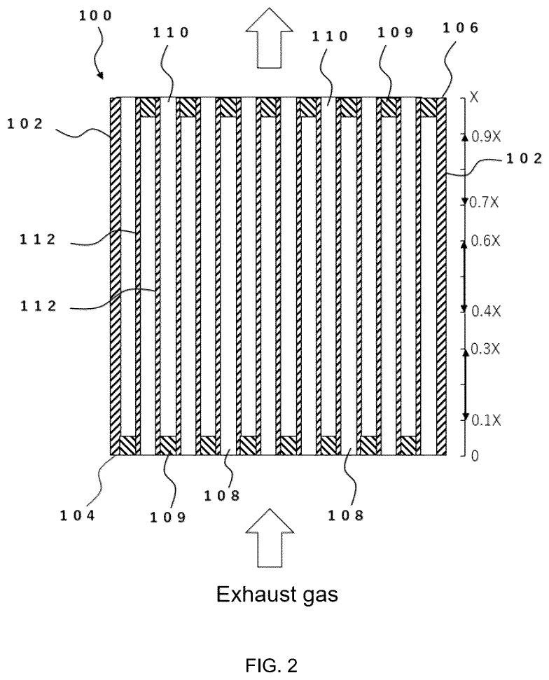

FIGS. 1 and 2 respectively illustrate a schematic perspective view and a cross-sectional view of a pillar-shaped honeycomb structure filter 100. This pillar-shaped honeycomb structure filter 100 comprises an outer peripheral side wall 102; a plurality of first cells 108 disposed on the inner peripheral side of the outer peripheral side wall 102, extending from an inlet side end surface 104 to an outlet side end surface 106, opening on the inlet side end surface 104 and having a sealing portion 109 on the outlet side end surface 106; and a plurality of second cells 110 disposed on the inner peripheral side of the outer peripheral side wall 102, extending from the inlet side end surface 104 to the outlet side end surface 106, having a sealing portion 109 on the inlet side end surface 104, and opening on the outlet side end surface 106. In this pillar-shaped honeycomb structure filter 100, the first cells 108 and the second cells 110 are alternately arranged adjacent to each other with the partition wall 112 interposed therebetween, and the inlet side end surface 104 and the outlet side end surface 106 each have a honeycomb shape.

When exhaust gas containing particulate matter (PM) such as soot is supplied to the inlet side end surface 104 that is on the upstream side of the pillar-shaped honeycomb structure filter 100, the exhaust gas is introduced into the first cells 108 and proceeds downstream inside the first cells 108. Since the first cells 108 are sealed at the outlet side end surface 106 that is on the downstream side, the exhaust gas passes through the porous partition walls 112 that partitions the first cells 108 and the second cells 110 and flows into the second cells 110. Since the particulate matter cannot pass through the partition walls 112, it is collected and deposited within the first cells 108. After the particulate matter has been removed, the clean exhaust gas that has entered the second cells 110 proceeds downstream within the second cells 110 and exits from the outlet side end surface 106 on the downstream side.

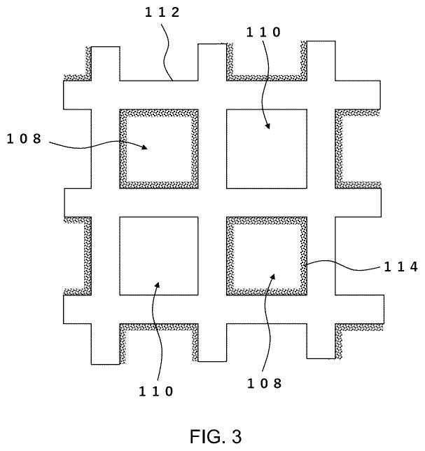

FIG. 3 shows a schematic partial enlarged view of the pillar-shaped honeycomb structure filter 100 when observed in a cross-section perpendicular to the direction in which the cells 108 and 110 extend. A porous film 114 is formed on the surface of each first cell 108 of the pillar-shaped honeycomb structure filter 100 (same as the surface of the partition walls 112 that partitions the first cell 108).

The porous film 114 is composed of a plurality of particles. A plurality of particles constituting the porous film 114 have a three-dimensional structure in which they are bonded to each other. When observing the porous film 114 in a cross-section parallel to the film thickness direction, and measuring the interparticle distance, which is the distance between adjacent particles in the direction perpendicular to the film thickness direction, for the plurality of particles constituting the porous film 114, to determine the frequency distribution of the interparticle distance, as the interparticle distance (D90) at which the cumulative ratio is 90% becomes shorter, PM collection performance tends to improve.

Specifically, the interparticle distance (D90) is preferably 12.0 μm or less, more preferably 11.0 μm or less, even more preferably 10.0 μm or less, even more preferably 9.0 μm or less, and even more preferably 8.0 μm or less. Although the lower limit of the interparticle distance (D90) is not particularly set, from the viewpoint of suppressing pressure loss and saturating the improvement effect of PM collection performance, D90 is preferably 0.5 μm or more, more preferably 0.75 μm or more, even more preferably 1.0 μm or more, even more preferably 1.5 μm or more, and even more preferably 2.0 μm or more. Therefore, the interparticle distance (D90) is, for example, preferably 0.5 to 12.0 μm, more preferably 0.75 to 11.0 μm, more preferably 1.0 to 10.0 μm, more preferably 1.5 to 9.0 μm, and even more preferably 2.0 to 8.0 μm.

When observing the porous film 114 in a cross-section parallel to the film thickness direction, and measuring the interparticle distance, which is the distance between adjacent particles in the direction perpendicular to the film thickness direction, for the plurality of particles constituting the porous film 114, to determine the frequency distribution of the interparticle distance, it is desirable that the (arithmetic) average value of the interparticle distance also be short in order to improve PM collection performance.

Specifically, the average value of the interparticle distance is preferably 5.3 μm or less, more preferably 5.0 μm or less, even more preferably 4.5 μm or less, and even more preferably 4.0 μm or less. Although there is no particular lower limit for the average value of interparticle distance, from the viewpoint of suppressing pressure loss and the fact the improvement effect of PM collection performance may saturate, the average value of the interparticle distance is preferably 0.25 μm or more, more preferably 0.5 μm or more, even more preferably 0.75 μm or more, and even more preferably 1.0 μm or more. Therefore, the average value of the interparticle distance is preferably 0.25 to 5.3 μm, more preferably 0.5 to 5.0 μm, even more preferably from 0.75 to 4.5 μm, and even more preferably from 1.0 to 4.0 μm.

When observing the porous film 114 in a cross-section parallel to the film thickness direction, and measuring the interparticle distance, which is the distance between adjacent particles in the direction perpendicular to the film thickness direction, for the plurality of particles constituting the porous film 114, to determine the frequency distribution of the interparticle distance, it is desirable that the standard deviation of the interparticle distance also be small in order to improve PM collection performance.

Specifically, the standard deviation of the interparticle distance is preferably 3.6 μm or less, more preferably 3.4 μm or less, and even more preferably 3.2 μm or less. The lower limit of the standard deviation of the interparticle distance is not particularly set, and it may be 0, but from the viewpoint of ease of manufacture, the standard deviation of the interparticle distance is preferably 0.5 μm or more, and more preferably 0.7 μm or more. Therefore, the standard deviation of the interparticle distance is, for example, preferably 0.5 to 3.6 μm, more preferably 0.5 to 3.4 μm, and even more preferably 0.7 to 3.2 μm.

When observing the porous film 114 in a cross-section parallel to the film thickness direction, the procedure for measuring the interparticle distance, which is the distance between adjacent particles in a direction perpendicular to the film thickness direction, for a plurality of particles constituting the porous film 114 is as follows. Samples (size=10 mm×10 mm×10 mm) are collected from near the center axis (radial center) near the inlet side end surface of the pillar-shaped honeycomb structure filter, near the center axis near the outlet side end surface, and near the center axis near the center in the height direction (longitudinal direction along which the cells extend), respectively.

Next, a cross-section parallel to the thickness direction of the porous film of each sample is observed using an electron microscope (SEM) at a magnification of 1000. Next, using image analysis software, the SEM image is subjected to binarization processing for the space portions and the solid portions.

The porous film is divided into three regions: near the boundary with the partition wall, near the outer surface, and near the center of the thickness. In each region, draw a straight line (length 70 μm, line width 0.5 μm on the scale on the SME image) perpendicular to the film thickness direction, and measure the line segment length of each space portion (=distance between particles) crossed by these straight lines to determine the frequency distribution.

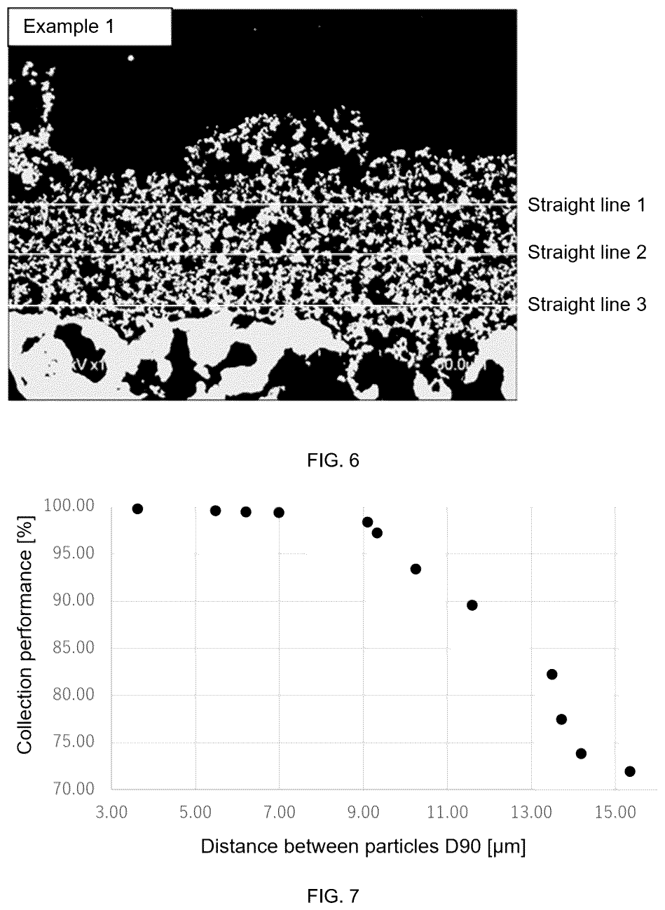

At this time, a straight line is drawn in a region near the boundary with the partition wall so that the partition wall portion is not included. In addition, although the outer surface is not necessarily flat and may have unevenness, straight lines are drawn in the area near the outer surface so as not to include space portions due to the unevenness forming the outer surface. Further, the three straight lines are drawn at equal intervals. FIG. 6 shows an example of a cross-sectional SEM image of the porous film of Example 1, as well as three straight lines.

In this way, the frequency distribution of interparticle distance is obtained for all the three samples, and three parameters are calculated for each sample: the interparticle distance (D90), the average value of the interparticle distance, and the standard deviation of the interparticle distance. Then, from the results of the three samples, the average value of each parameter is determined and used as the measured value for the pillar-shaped honeycomb structure filter.

The lower limit of the average thickness of the porous film is preferably 2 μm or more, more preferably 4 μm or more, and even more preferably 6 μm or more, from the viewpoint of improving PM collection performance. Further, from the viewpoint of suppressing an increase in pressure loss, the upper limit of the average thickness of the porous film is preferably 40 μm or less, more preferably 35 μm or less, and even more preferably 30 μm or less. Therefore, the average thickness of the porous film is, for example, preferably 2 to 40 μm, more preferably 4 to 35 μm, and even more preferably 6 to 30 μm.

The average thickness of the porous film is measured by the following method. The direction in which the first cells of the pillar-shaped honeycomb structure filter extend is set as the direction in which a coordinate axis extends, the coordinate value of the inlet side end surface is set to 0, and the coordinate value of the outlet side end surface is set to X. Then, the average thickness of the porous film is measured at the following six locations A₁, A₂, A₃, B₁, B₂, and B₃, each for five fields of view, and the average value of all these is taken as the average film thickness of the porous film of the pillar-shaped honeycomb structure filter.

A₁: Center portion in a cross-section perpendicular to the direction in which the first cells of the pillar-shaped honeycomb structure filter extend, in the coordinate value range of 0.1× to 0.3×.

B₁: Outer peripheral portion in a cross-section perpendicular to the direction in which the first cells of the pillar-shaped honeycomb structure filter extend, in the coordinate value range of 0.1× to 0.3×.

A₂: Center portion in a cross-section perpendicular to the direction in which the first cells of the pillar-shaped honeycomb structure filter extend, in the coordinate value range of 0.4× to 0.6×.

B₂: Outer peripheral portion in a cross-section perpendicular to the direction in which the first cells of the pillar-shaped honeycomb structure filter extend, in the coordinate value range of 0.4× to 0.6×.

A₃: Center portion in a cross-section perpendicular to the direction in which the first cells of the pillar-shaped honeycomb structure filter extend, in the coordinate value range of 0.7× to 0.9×.

B₃: Outer peripheral portion in a cross-section perpendicular to the direction in which the first cells of the pillar-shaped honeycomb structure filter extend, in the coordinate value range of 0.7× to 0.9×.

When measuring the average thickness of the porous film, the center portion and outer peripheral portion of the pillar-shaped honeycomb structure filter are determined as follows. When observing the pillar-shaped honeycomb structure filter from a cross-section perpendicular to the direction in which the first cells extend, a line segment is drawn from the center of gravity of the cross-section toward the outer surface of the outer peripheral side wall. The direction in which the line segment extends is set as the direction in which a coordinate axis extends, the coordinate value of the center of gravity is set to 0, and the coordinate value of the outer surface of the outer peripheral side wall is set to R. In this case, in this line segment, the range of coordinate values 0 to 0.2R is the center portion, and the range of coordinate values 0.7R to 0.9R is the outer peripheral portion. In this manner, a large number of such line segments are drawn in the cross-section, and the center portion and the outer peripheral portion of each line segment are collected, thereby obtaining the area of the center portion and outer peripheral portion in this cross-section.

The average thickness of the porous film at each location A₁, A₂, A₃, B₁, B₂, and B₃ is measured by the following method. From the point (center portion or outer peripheral portion) where the average thickness of the porous film of the pillar-shaped honeycomb structure filter is to be determined, a cross-section is cut out that is parallel to the direction in which the first cells extend and parallel to a line segment from the outer surface of the outer peripheral side wall toward the center of gravity. The cross-section is observed using a 3D shape measuring device (for example, VR-3200 manufactured by Keyence Corporation) at a magnification of 25 times and an observation field of 12.5 mm (horizontal)×9.5 mm (vertical). At this time, the observation is performed so that the horizontal direction of the observation field is parallel to the direction in which the first cells extend.

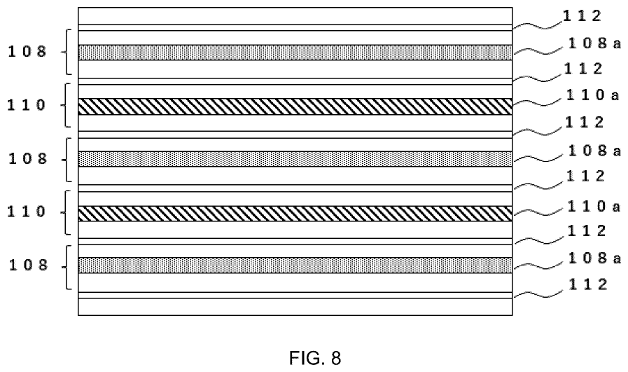

FIG. 8 shows a schematic diagram of a cut out cross-section. By observing the cross-section, the first cells 108 on which the porous film is formed and the second cells 110 on which the porous film is not formed are identified. Next, three first cells 108 that are adjacent to each other at a position closest to the center on the cross-section are identified. In addition, each of the central regions 110a (reference planes) of the two second cells 110 sandwiched between these three adjacent first cells 108 at the position closest to the center on the cross-section is identified, and leveling is performed using an image processing software (for example, the software included with the 3D shape measuring machine VR-3200 manufactured by Keyence Corporation) such that the reference planes are horizontal at most based on the profiles of both regions. After the leveling, a range is designated for the central regions 110a of the two second cells 110, and the average height H2 of that region is measured. Further, after the leveling, a range is designated for the central regions 108a of the three first cells 108, and the average height H1 of that region is measured. The difference between the average height H1 and the average height H2 in one field of view is defined as the average thickness of the porous film in the field of view. In addition, the central regions 108a and 110a refer to the region at the center when the distance between the pair of partition walls 112 that partitions each cell is divided into thirds.

For each location of A₁, A₂, A₃, B₁, B₂, and B₃, the average thickness of the porous film in five arbitrary fields of view is calculated, and set as the average thickness of the porous film at each location of A₁, A₂, A₃, B₁, B₂, and B₃. Then, the average value of all these values is taken as the average film thickness of the porous film of the pillar-shaped honeycomb structure filter.

The porous film can be made of ceramics. For example, the porous film can contain one or more ceramics selected from cordierite, silicon carbide (SiC), talc, mica, mullite, cerbenes, aluminum titanate, alumina, silicon nitride, sialon, zirconium phosphate, zirconia, titania and silica. The main component of the porous film is preferably silicon carbide, alumina, silica, cordierite or mullite. Among these, it is preferable that the main component of the porous film is silicon carbide, since the presence of the surface oxide film (Si₂O) provides a porous film that is strongly bonded to each other and is difficult to peel off. The main component of the porous film refers to a component that accounts for 50% by mass or more of the porous film. In the porous film, SiC preferably accounts for 50% by mass or more, more preferably 70% by mass or more, and even more preferably 90% by mass or more. The shape of the ceramics constituting the porous film is not particularly limited, and examples include granular and fibrous shapes.

The material constituting the partition walls and outer peripheral side walls of the pillar-shaped honeycomb structure filter includes, but is not limited to, porous ceramics. Examples of the types of ceramics include cordierite, mullite, zirconium phosphate, aluminum titanate, silicon carbide (SiC), silicon-silicon carbide composite (for example, Si-bonded SiC), cordierite-silicon carbide composite, zirconia, spinel, indialite, sapphirine, corundum, titania, silicon nitride, and the like. For these ceramics, one type may be contained alone, or two or more types may be contained.

A pillar-shaped honeycomb structure filter may carry a PM combustion catalyst that assists in the combustion of PM such as soot, a diesel oxidation catalyst (DOC), an SCR and an NSR catalysts for removing nitrogen oxides (NOx), and a three-way catalyst that can simultaneously remove hydrocarbons (HC), carbon monoxide (CO), and nitrogen oxides (NOx). The pillar-shaped honeycomb structure filter according to this embodiment may also carry various catalysts.

Although there is no restriction on the shape of end surfaces of the pillar-shaped honeycomb structure filter, it can be, for example, round shapes such as a circle, an ellipse, a racetrack shape, and a long circle, as well as polygons such as a triangle and a quadrangle. The pillar-shaped honeycomb structure filter 100 shown in FIG. 1 has a circular end surface shape, and is cylindrical as a whole.

The height of the pillar-shaped honeycomb structure filter (the length from the inlet side end surface to the outlet side end surface) is not particularly limited and may be set as appropriate depending on the use and required performance. There is also no particular restriction on the relationship between the height of the pillar-shaped honeycomb structure filter and the maximum diameter of each end surface (referring to the maximum length of line segments passing through the center of gravity of each end surface of the pillar-shaped honeycomb structure filter). Therefore, the height of the pillar-shaped honeycomb structure filter may be longer than the maximum diameter of each end surface, or the height of the pillar-shaped honeycomb structure filter may be shorter than the maximum diameter of each end surface.

Although there is no restriction on the shape of the cell in a cross-section perpendicular to the direction in which the cells extend, it is preferably quadrangular, hexagonal, octagonal, or a combination thereof. Among these, square and hexagonal shapes are preferred. By configuring the cell shape in this manner, it is possible to reduce pressure loss when a fluid flows through the pillar-shaped honeycomb structure filter.

The pillar-shaped honeycomb structure filter can also be provided as an integrally molded product. Moreover, the pillar-shaped honeycomb structure filter can also be provided as a segment joined body by joining the segments of a plurality of pillar-shaped honeycomb structure filters, each having an outer peripheral side wall, together at their side surfaces and integrating them. By providing the pillar-shaped honeycomb structure filter as a segment assembly, thermal shock resistance can be improved.

From the viewpoint of suppressing the pressure loss of exhaust gas, the lower limit of the porosity of the partition walls is preferably 40% or more, more preferably 44% or more, and even more preferably 48% or more. Further, from the viewpoint of ensuring the strength of the pillar-shaped honeycomb structure filter, the upper limit of the porosity of the partition walls is preferably 75% or less, more preferably 70% or less, and even more preferably 65% or less. Therefore, the porosity of the partition wall is, for example, preferably 40 to 75%, more preferably 44 to 70%, and even more preferably 48 to 65%.

The porosity of the partition wall is measured by the following method. Samples (size=10 mm×10 mm×10 mm) are collected from near the center axis (radial center) near the inlet side end surface of the pillar-shaped honeycomb structure filter, near the center axis near the outlet side end surface, and near the center axis near the center in the height direction (longitudinal direction along which the cells extend), respectively. Next, a cross-section of the partition walls of each sample (size per field: 150 μm×150 μm) is photographed using a SEM (scanning electron microscope) at a magnification of 1000 times, and is subjected to binarization processing using an image analysis software for the space portions and solid portions. Next, the area ratio occupied by the space portions in the field of view is determined, and the average value of this ratio is calculated to determine the porosity (%) of the partition walls in the sample. Then, the average value of the porosity of the three samples is determined, and this is taken as the measured value for the pillar-shaped honeycomb structure filter.

From the viewpoint of suppressing pressure loss, the upper limit of the average thickness of the partition walls in the pillar-shaped honeycomb structure filter is preferably 0.37 mm or less, more preferably 0.35 mm or less, and even more preferably 0.33 mm or less. However, from the viewpoint of ensuring the strength of the pillar-shaped honeycomb structure filter, the lower limit of the average thickness of the partition walls is preferably 0.10 mm or more, more preferably 0.13 mm or more, and even more preferably 0.15 mm or more. Therefore, for example, the average thickness of the partition walls in the pillar-shaped honeycomb structure filter is preferably 0.10 to 0.37 mm, more preferably 0.13 to 0.35 mm, and even more preferably 0.15 to 0.33 mm.

In this specification, the thickness of a partition wall refers to a crossing length of a line segment that crosses the partition wall when the centers of gravity of adjacent cells are connected by this line segment in a cross-section orthogonal to the direction in which the cells extend. The average thickness of the partition walls refers to the average value of the thicknesses of all the partition walls.

The cell density (the number of cells per unit cross-sectional area perpendicular to direction in which the cells extend) is not particularly limited, but for example, it can be 6 to 2000 cells/square inch (0.9 to 311 cells/cm²), more preferably 50 to 1000 cells/square inch (7.8 to 155 cells/cm²), particularly preferably 100 to 400 cells/square inch (15.5 to 62.0 cells/cm²).

The pillar-shaped honeycomb structure filter can also be provided as an integrally molded product. Moreover, the pillar-shaped honeycomb structure filter can also be provided as a segment joined body by joining the segments of a plurality of pillar-shaped honeycomb structure filters, each having an outer peripheral side wall, together at their side surfaces and integrating them. By providing the pillar-shaped honeycomb structure filter as a segment assembly, thermal shock resistance can be improved.

### <2. Method for Manufacturing Pillar-Shaped Honeycomb Structure Filter>

A method for manufacturing a pillar-shaped honeycomb structure filter will be exemplified as below. First, a raw material composition containing a ceramic raw material, a dispersion medium, a pore-forming material, and a binder is kneaded to form a green body, and then the green body is extruded to form a desired pillar-shaped honeycomb formed body. Additives such as a dispersant may be added to the raw material composition as necessary. For extrusion molding, a die having a desired overall shape, cell shape, partition wall thickness, cell density, and the like can be used.

After drying the pillar-shaped honeycomb formed body, sealing portions are formed at predetermined positions on both end surfaces of the pillar-shaped honeycomb formed body, and the sealing portions are dried to obtain a pillar-shaped honeycomb formed body having sealing portions. Thereafter, the pillar-shaped honeycomb formed body is degreased and fired to obtain a pillar-shaped honeycomb structure body. Thereafter, a porous film is formed on the surface of the first cells of the pillar-shaped honeycomb structure body, thereby obtaining a pillar-shaped honeycomb structure filter.

The ceramic raw material is the raw material for the portions that remains after firing and forms the skeletal structure of the honeycomb structure body as a ceramic. As the ceramic raw material, a raw material that can form the above-mentioned ceramics after firing can be used. The ceramic raw material can be provided in the form of a powder, for example. Examples of ceramic raw materials include raw materials for obtaining ceramics such as cordierite, mullite, zircon, aluminum titanate, silicon carbide, silicon nitride, zirconia, spinel, indialite, sapphirine, corundum, and titania. Specific examples include, but are not limited to, silica, talc, alumina, kaolin, serpentine, pyroferrite, brucite, boehmite, mullite, magnesite, aluminum hydroxide, and the like. The ceramic raw materials may be used alone or in combination of two or more.

In the case of filter applications such as DPF and GPF, cordierite can be suitably used as the ceramic. In this case, a cordierite-forming raw material can be used as the ceramic raw material. The cordierite-forming raw material is a raw material that becomes cordierite by firing. It is desirable that the cordierite-forming raw material have a chemical composition of: alumina (Al₂O₃) (including aluminum hydroxide that converts to alumina): 30 to 45% by mass, magnesia (MgO): 11 to 17% by mass, and silica (SiO₂): 42 to 57% by mass.

Examples of the dispersion medium include water or a mixed solvent of water and an organic solvent such as alcohol, and water can be particularly preferably used.

The pore-forming material is not particularly limited as long as it forms pores after firing, and for example, mention can be made to flour, starch, foamed resin, water absorbent resin, silica gel, carbon (for example, graphite), ceramic balloon, polyethylene, polystyrene, polypropylene, nylon, polyester, acrylic, phenol, and the like. As the pore-forming material, one type may be used alone, and two or more types may be used in combination. From the viewpoint of increasing the porosity of the fired body, the content of the pore-forming material is preferably 0.5 parts by mass or more, more preferably 2 parts by mass or more, and even more preferably 3 parts by mass or more, with respect to 100 parts by mass of the ceramic raw material. From the viewpoint of ensuring the strength of the fired body, the content of the pore-forming material is preferably 10 parts by mass or less, more preferably 7 parts by mass or less, and 4 parts by mass or less, with respect to 100 parts by mass of the ceramic raw material.

As the binder, examples include organic binders such as methyl cellulose, hydroxypropyl methyl cellulose, hydroxyethyl cellulose, carboxymethyl cellulose, and polyvinyl alcohol. In particular, it is suitable to use methyl cellulose and hydroxypropyl methyl cellulose in combination. Further, from the viewpoint of increasing the strength of the honeycomb formed body before firing, the content of the binder is preferably 4 parts by mass or more, more preferably 5 parts by mass or more, and even more preferably 6 parts by mass or more, with respect to 100 parts by mass of the ceramic raw material. From the viewpoint of suppressing the occurrence of crack due to abnormal heat generation in a firing step, the content of the binder is preferably 9 parts by mass or less, more preferably 8 parts by mass or less, and even more preferably 7 parts by mass or less, with respect to 100 parts by mass of the ceramic raw material. As the binder, one type may be used alone, and two or more types may be used in combination.

As the dispersant, ethylene glycol, dextrin, fatty acid soap, polyether polyol, and the like can be used. As the dispersant, one type may be used alone, and two or more types may be used in combination. The content of the dispersant is preferably 0 to 2 parts by mass with respect to 100 parts by mass of the ceramic raw material.

The method for sealing the end surfaces of the pillar-shaped honeycomb formed body is not particularly limited, and any known method may be employed. There are no particular restrictions on the material of the sealing portions, but from the viewpoint of strength and heat resistance, ceramics are preferred. The ceramic material is preferably a ceramic material containing at least one selected from the group consisting of cordierite, mullite, zircon, aluminum titanate, silicon carbide, silicon nitride, zirconia, spinel, indialite, sapphirine, corundum, and titania. It is even more preferable that the sealing portions have the same material composition as the main body portion of the honeycomb formed body, since the expansion coefficient during firing can be made the same, leading to improved durability.

After drying the honeycomb formed body, a pillar-shaped honeycomb structure body can be manufactured by performing degreasing and firing. As the conditions for the drying step, degreasing step, and firing step, known conditions may be adopted depending on the material composition of the honeycomb formed body. Although no special explanation is required, specific examples of the conditions are listed below.

In the drying step, conventionally known drying methods such as hot wind drying, microwave drying, dielectric drying, reduced pressure drying, vacuum drying, and freeze drying can be used. Among these, a drying method that combines hot wind drying with microwave drying or dielectric drying is preferable since the entire honeycomb formed body can be dried quickly and uniformly.

When forming sealing portions, it is preferable to form the sealing portions on both end surfaces of the dried honeycomb formed body and then dry the sealing portions. The sealing portions are formed at predetermined positions such that a plurality of first cells and a plurality of second cells are alternately arranged adjacent to each other with porous partition walls interposed therebetween, wherein the plurality of first cells extend from the inlet side end surface to the outlet side end surface, opening on the inlet side end surface and having a sealing portion on the outlet side end surface, and the plurality of second cells extend from the inlet side end surface to the outlet side end surface, having a sealing portion on the inlet side end surface and opening on the outlet side end surface.

Next, the degreasing step will be explained. The combustion temperature of the binder is about 200° C., and the combustion temperature of the pore-forming material is about 300 to 1000° C. Therefore, the degreasing step may be carried out by heating the honeycomb formed body to a temperature in the range of about 200 to 1000° C. The heating time is not particularly limited, but is usually about 10 to 100 hours. The honeycomb formed body after the degreasing process is called a calcined body.

The firing step can be carried out, for example, by heating the calcined body to 1350 to 1600° C. and holding it for 3 to 10 hours, although it depends on the material composition of the honeycomb formed body. In this way, a pillar-shaped honeycomb structure body is produced, comprising a plurality of first cells extending from an inlet side end surface to an outlet side end surface, opening on the inlet side end surface and having a sealing portion on the outlet side end surface; and a plurality of second cells extending from the inlet side end surface to the outlet side end surface, having a sealing portion on the inlet side end surface and opening on the outlet side end surface, the plurality of first cells and the plurality of second cells alternately arranged adjacent to each other with the porous partition wall interposed therebetween.

Next, a porous film is formed on the surface of the first cells of the pillar-shaped honeycomb structure body that has undergone the firing process. First, a step of adhering ceramic particles to the surface of the first cells is performed by injecting an aerosol containing ceramic particles toward the inlet side end surface of the pillar-shaped honeycomb structure body from a direction perpendicular to the inlet side end surface, preferably toward the center of the inlet side end surface, while applying a suction force to the outlet side end surface to suck the injected aerosol from the inlet side end surface. Illustratively, the distance between the aerosol injection nozzle and the inlet side end surface may be 500 mm to 2000 mm.

Aerosols can be injected using an aerosol generator. In one embodiment, the aerosol generator has an accommodating section that accommodates ceramic particles, and is configured such that the ceramic particles are supplied from the accommodating section to a nozzle, and the aerosol is injected from the nozzle.

Regarding the plurality of particles that constitute the porous film, in order to shorten the interparticle distance and form a dense porous film, it is preferable that ceramic particles having a BET specific surface area of 3.5 m²/g or more be accommodated in the accommodating section. Although the present invention is not intended to be limited by theory, it is believed that when the BET specific surface area is large, the particles become bulky and are dispersed more uniformly when injected as an aerosol during the film formation, so that the interparticle distance can be shortened. The lower limit of the BET specific surface area of the ceramic particles accommodated in the accommodation section is more preferably 4.0 m²/g or more, more preferably 6.0 m²/g or more, more preferably 8.0 m²/g or more, more preferably 10.0 m²/g or more, more preferably 12.0 m²/g or more, more preferably 14.0 m²/g or more, and even more preferably 16.0 m²/g or more. Although the upper limit of the BET specific surface area of the ceramic particles accommodated in the accommodating section is not particularly set, it is preferably 100.0 m²/g or less, more preferably 90.0 m²/g or less, and even more preferably 80.0 m²/g or less, since the collection performance tends to be saturated even though the manufacturing cost becomes higher. Therefore, the BET specific surface area of the ceramic particles accommodated in the accommodation section is preferably 3.0 to 100.0 m²/g, more preferably 4.0 to 90.0 m²/g, more preferably 6.0 to 80.0 m²/g, more preferably 8.0 to 80.0 m²/g, more preferably 10.0 to 80.0 m²/g, more preferably 12.0 to 80.0 m²/g, more preferably 14.0 to 80.0 m²/g, and even more preferably 16.0 to 80.0 m²/g.

Examples of methods for increasing the BET specific surface area of ceramic particles include reducing the size of raw material particles, or changing the grinding method (from a jet mill to a ball mill), or the like. On the other hand, as a method for reducing the BET specific surface area of ceramic particles, for example, there is a method of increasing the size of raw material particles.

The BET specific surface area of the ceramic particles is measured according to the BET single point method based on the method of JIS Z8830: 2013.

In addition to controlling the BET specific surface area, it is advantageous to control the particle diameter of the ceramic particles in order to shorten the interparticle distance and form a dense porous film. Specifically, it is preferable that the upper limit of the median diameter (D50) of the ceramic particles accommodated in the accommodation section in the volume-based cumulative particle diameter distribution measured by laser diffraction/scattering method be 3.0 μm or less, more preferably 2.5 μm or less, and even more preferably 2.0 μm or less. Further, the lower limit of the median diameter (D50) is preferably 0.5 μm or more, more preferably 0.7 μm or more, and even more preferably 0.9 μm or more. Therefore, the median diameter (D50) is, for example, preferably 0.5 to 3.0 μm, more preferably 0.7 to 2.5 μm, and even more preferably 0.9 to 2.0 μm.

As the ceramic particles, the above-mentioned ceramic particles constituting the porous film are used. For example, ceramic particles containing one or more selected from cordierite, silicon carbide (SiC), talc, mica, mullite, cerbenes, aluminum titanate, alumina, silicon nitride, sialon, zirconium phosphate, zirconia, titania and silica can be used. The main component of the ceramic particles is preferably silicon carbide, alumina, silica, cordierite or mullite. The main component of the ceramic particles refers to a component that accounts for 50% by mass or more of the ceramic particles. In the ceramic particles, SiC preferably accounts for 50% by mass or more, more preferably 70% by mass or more, and even more preferably 90% by mass or more.

The ceramic particles accommodated in the accommodating section may aggregate over time. In particular, fine ceramic particles tend to aggregate easily. For this reason, it is preferable to loosen the agglomeration before injecting the ceramic particles from the nozzle of the aerosol generator. Therefore, it is preferable that the aerosol generator comprises a driving gas flow path for flowing pressurized driving gas, a supply port provided in the middle of the driving gas flow path and capable of sucking ceramic particles from the accommodating section from the outer peripheral side of the driving gas flow path into the driving gas flow path, and a nozzle that is adhered to the tip of the driving gas flow path and capable of injecting the aerosol. When ceramic particles are supplied from the outer peripheral side of the driving gas flow path toward the inside of the driving gas flow path, the driving gas has a higher crushing effect on the ceramic particles, so it becomes possible to inject the ceramic particles whose aggregation is suppressed from the nozzle of the aerosol generator. In one embodiment, the supply port can be configured such that the ceramic particles are introduced into the driving gas flow path from a direction substantially perpendicular to the flow direction of the driving gas flowing through the driving gas flow path.

### (Aerosol Generator)

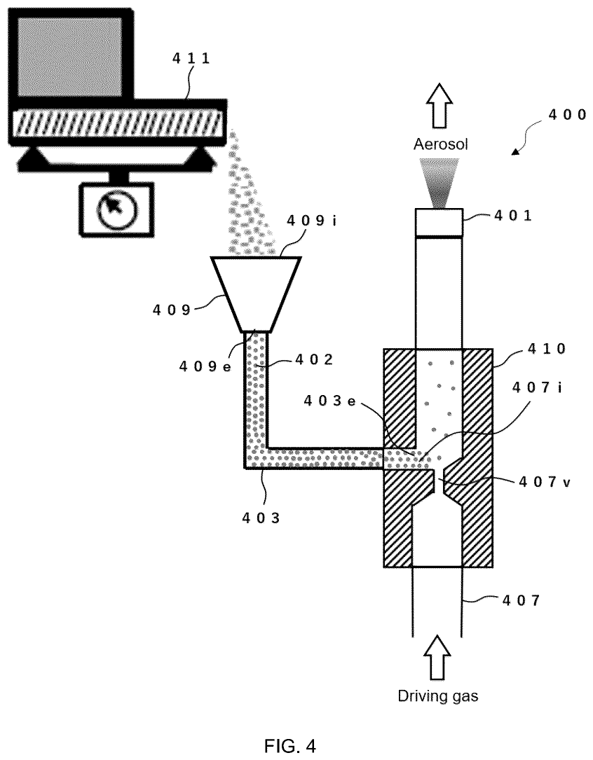

FIG. 4 schematically shows a configuration example of an aerosol generator 400 suitable for injecting ceramic particles with suppressed aggregation.

The aerosol generator 400 comprises:
a driving gas flow path 407 for flowing pressurized driving gas;
a supply port 407i that is provided on the way of the driving gas flow path 407 and capable of sucking the ceramic particles 402 from the outer peripheral side of the driving gas flow path 407 into the driving gas flow path 407;
a nozzle 401 that is attached to the tip of the driving gas flow path 407 and capable of injecting an aerosol;
a flow path 403 for sucking and conveying the ceramic particles 402, the flow path 403 comprising an outlet 403e communicating with the supply port 407i; and
an accommodating section 409 for accommodating the ceramic particles 402 and supplying the ceramic particles 402 to a flow path 403 for suction and conveyance;

For example, a funnel can be used as the accommodating section 409. Ceramic particles having a predetermined BET specific surface area are housed in the accommodating section 409. The ceramic particles 402 accommodated in the accommodating section 409 are conveyed from the outlet 409e provided at the bottom of the accommodating section 409 through the flow path 403 to the outlet 403e under the suction force from the driving gas flow path 407, and is then introduced into the driving gas flow path 407 from the supply port 407i. At this time, ambient gas (typically, the air) sucked from the inlet 409i of the accommodating section 409 is also introduced into the driving gas flow path 407 through the flow path 403 together with the ceramic particles 402. In the illustrated aerosol generator 400, the outlet 403e and the supply port 407i are common. Furthermore, in the illustrated aerosol generator 400, the ceramic particles 402 are introduced into the driving gas flow path 407 from a direction substantially perpendicular to the flow direction of the driving gas flowing through the driving gas flow path 407.

The ceramic particles 402 supplied into the driving gas flow path 407 collide with the driving gas flowing through the driving gas flow path 407, are mixed while being crushed, and become an aerosol, which is injected from the nozzle 401. It is preferable that the nozzle 401 be installed in a position and direction such that the aerosol is injected in a direction perpendicular to the inlet side end surface of the pillar-shaped honeycomb structure body. More preferably, the nozzle 401 is installed in such a position and direction that the aerosol is injected toward the center of the inlet side end surface in a direction perpendicular to the inlet side end surface.

The ceramic particles 402 are preferably supplied to the accommodating section 409 using a powder metering feeder 411 such as, for example, a screw feeder or a belt conveyor, although the supply method is not limited thereto. The ceramic particles 402 discharged from the powder metering feeder 411 can be dropped into the accommodating section 409 by gravity.

In a preferred embodiment, the driving gas flow path 407 has a venturi portion 407v on the way by which the flow path is constricted, and the supply port 407i is provided downstream of the part of the venturi portion 407v where the flow path is most constricted. When the driving gas flow path 407 includes the venturi portion 407v, the speed of the driving gas passing through the venturi portion 407v increases, so that driving gas with higher speed can collide with the ceramic particles 402 supplied downstream of the venturi portion 407v, which improves the crushing force. In order to increase the crushing force of the driving gas, it is more preferable that the supply port 407i be provided downstream of and adjacent to the part of the venturi portion 407v where the flow path is most constricted. This configuration can be realized, for example, by connecting the driving gas flow path 407 and the flow path 403 for suction and conveyance using a venturi ejector 410.

From the viewpoint of increasing the crushing force of the ceramic particles, the lower limit of the flow velocity of the driving gas immediately before passing through the venturi portion 407v is preferably 13 m/s or more, more preferably 20 m/s or more, and even more preferably 26 m/s or more. Although the upper limit of the flow velocity of the driving gas immediately before passing through the venturi portion 407v is not particularly set, it is usually 50 m/s or less, and typically 40 m/s or less.

From the viewpoint of increasing the crushing force, the lower limit of the ratio of the flow path cross-sectional area immediately before the venturi portion to the flow path cross-sectional area of the venturi portion is preferably 8 or more, more preferably 16 or more. The upper limit of the ratio of the flow path cross-sectional area immediately before the venturi portion to the flow path cross-sectional area of the venturi portion is not particularly limited, but if it is too large, the pressure drop in the venturi portion will increase, so it is preferably 64 or less, and more preferably 32 or less. Here, the flow path cross-sectional area of the venturi portion means the cross-sectional area of the flow path at the narrowest location in the venturi portion. In addition, the flow path cross-sectional area immediately before the venturi portion means the cross-sectional area of the flow path immediately before the flow path narrows on the upstream side of the venturi portion.

When the venturi ejector 410 is used, for example, when driving gas is caused to flow through the driving gas flow path 407, a large suction force can be applied to the flow path 403 for suction and conveyance and it is possible to prevent the flow path 403 for suction and conveyance from being clogged with the ceramic particles 402. The venturi ejector 410 is also effective as a means for removing the ceramic particles 402 when the flow path 403 for suction and conveyance is clogged with the ceramic particles 402.

By using a compressed gas such as pressure-adjusted compressed air as the driving gas, it is possible to control the flow rate of the aerosol injected from the nozzle 401. As the driving gas, it is preferable to use dry air (for example, with a dew point of 10° C. or lower) in order to suppress agglomeration of ceramic particles. In addition, in this specification, “dew point” refers to the value measured by a high molecular-type capacitance type dew point meter based on JIS Z8806: 2001.

### (Particle Adhesion Device)

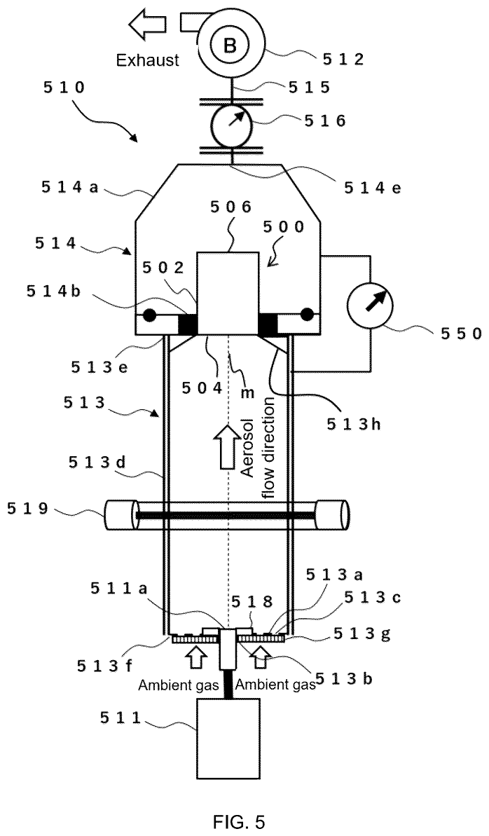

FIG. 5 schematically shows a configuration example of a particle adhesion device 510 suitable for carrying out the step of adhering ceramic particles to the surface of the first cells of a pillar-shaped honeycomb structure body.

The particle adhesion device 510 comprises:
a holder 514 for holding the pillar-shaped honeycomb structure body 500;
a blower 512 for applying a suction force to the outlet side end surface 506 of the pillar-shaped honeycomb structure body 500;
an aerosol generator 511 for injecting an aerosol containing ceramic particles toward the inlet side end surface 504 from a direction perpendicular to the inlet side end surface 504 to adhere the ceramic particles to the surface of the first cells; and
a chamber 513 provided between the nozzle 511a of the aerosol generator 511 and the inlet side end surface 504 for guiding the aerosol through the inside thereof.

The holder 514 is configured to be able to hold the pillar-shaped honeycomb structure body 500 at a position facing the nozzle 511a of the aerosol generator 511 with the inlet side end surface 504 exposed. For example, the holder 514 can have a chuck mechanism 514b for gripping the outer peripheral side wall 502. Although there is no particular restriction on the chuck mechanism, a balloon chuck can be exemplified. Furthermore, the holder 514 can include a housing 514a for rectifying the aerosol that has passed through the pillar-shaped honeycomb structure body 500 in one direction without diffusing.

The side wall 513d of the chamber 513 can be formed into a cylindrical shape, such as a cylindrical shape or a rectangular tube, for example. The chamber 513 has a surface 513a facing the inlet side end surface 504. A surface 513a facing the inlet side end surface 504 has an insertion port 513b for the nozzle 511a of the aerosol generator 511. With this configuration, the aerosol injected from the aerosol generator 511 can be directly introduced into the chamber 513. Typically, the downstream end 513e of the side wall 513d of the chamber 513 is connected to the holder 514, and the facing surface 513a is provided at an upstream end 513f of the side wall 513d of the chamber 513, which is opposite to the downstream end 513e.

The side wall 513d and/or the surface 513a facing the inlet side end surface 504 can be provided with an opening 513c for taking in the ambient gas. Thereby, the flow rate of gas flowing into the chamber 513 can be adjusted according to the suction force from the blower 512. However, as shown in FIG. 5, it is preferable that the side wall 513d of the chamber 513 is not provided with an opening 513c for taking in the ambient gas, and the ambient gas flowing into the chamber 513 is taken in only through the opening 513c provided in the surface 513a facing the inlet side end surface 504.

By taking in the ambient gas only from the surface 513a facing the inlet side end surface 504, since the ambient gas flows in the same direction as the flow direction of the injected aerosol, there is an advantage that there is no disturbance to the aerosol and the aerosol is stabilized. On the other hand, if the side wall 513d of the chamber 513 has the opening 513c, the ambient gas flowing in through the opening 513c tends to cause a disturbance, which is disadvantageous because the flow of the aerosol becomes unstable. Therefore, in a preferred embodiment, the surface 513a facing the inlet side end surface 504 has one or more openings 513c for introducing the ambient gas into the chamber 513, and there is no opening other than the facing surface 513a for introducing the ambient gas into the chamber 513.

The facing surface 513a of the chamber 513 may have a concentric closing portion 518 centered on the insertion port 513b. In that case, one or more openings 513c for taking the ambient gas into the chamber 513 are provided on the outer peripheral side of the closing portion 518. Although there is no particular restriction on the method of forming the closing portion 518, in one embodiment, a disc-shaped plate having an insertion port 513b for the nozzle 511a can be used.

By providing the closing portion 518, the ambient gas is prevented from flowing in from around the nozzle 511a of the aerosol generator 511. On the other hand, the ambient gas flows in from near the side wall 513d of the chamber 513. As a result, the aerosol injected from the nozzle 511a is drawn into the ambient gas that flows in from the opening 513c and flows near the side wall 513d. This provides the advantage that the aerosol is more likely to spread uniformly in the direction perpendicular to the flow direction of the aerosol. The closing portion 518 can close, for example, 50 to 87%, and typically 70 to 80%, of the area of the facing surface (inner surface) 513a of the chamber 513. Here, the area of the facing surface (inner surface) 513a includes the non-opening portion, the insertion port 513b, and the opening 513c.

A punching plate and/or a nonwoven fabric can be used on the facing surface 513a of the chamber 513. Furthermore, since there is a possibility that aggregated powder, honeycomb fragments, and dust may be caught in the opening 513c, a filter 513g may be installed.

When the cross-sectional area of the flow path of the aerosol flowing through the chamber 513 is larger than the size of the inlet side end surface 504, a tapered portion 513h may be provided at the downstream end 513e of the side wall 513d so that the cross-sectional area of the flow path gradually decreases toward the inlet side end surface 504. It is preferable that the contour of the cross-section of the flow path formed by the tapered portion 513h at the downstream end 513e of the side wall 513d match the outer peripheral contour of the inlet side end surface 504. By providing the tapered portion 513h, ceramic particles are easily sucked into the inlet side end surface 504.

The distance L from the outlet of the nozzle 511a to the inlet side end surface 504 of the pillar-shaped honeycomb structure body 500 is preferably designed according to the area A of the inlet side end surface 504 of the pillar-shaped honeycomb structure body 500. Specifically, it is preferable to increase the distance L (mm) as the area A (mm²) increases because the aerosol tends to spread uniformly in the direction perpendicular to the flow direction of the aerosol.

After the aerosol injected from the aerosol generator 511 passes through the chamber 513 due to the suction force from the blower 512, it is sucked into the first cells of the pillar-shaped honeycomb structure body 500 from the inlet side end surface 504 of the pillar-shaped honeycomb structure body 500 held by the holder 514. Ceramic particles in the aerosol sucked into the first cells adhere to the surface of the first cells.

The housing 514a of the holder 514 has an exhaust port 514e on the downstream side of the outlet side end surface 506 of the pillar-shaped honeycomb structure body 500. The exhaust port 514e is connected to an exhaust pipe 515, and a blower 512 is provided downstream thereof. Therefore, when the aerosol from which the ceramic particles have been removed is discharged from the outlet side end surface 506 of the pillar-shaped honeycomb structure body 500, it passes through the exhaust pipe 515 and is then exhausted through the blower 512. A flow meter 516 is installed in the exhaust pipe 515, and the gas flow rate measured by the flow meter 516 can be monitored, and the strength of the blower 512 can be controlled according to the required gas flow rate.

From the viewpoint of increasing the stability of the thickness of the ceramic particles adhered to the surface of the first cell, in the step of adhering ceramic particles to the surface of the first cells, the average flow rate of the aerosol flowing inside the chamber 513 is preferably 0.5 m/s to 3.0 m/s, more preferably 1.0 to 2.0 m/s.

From the viewpoint of increasing the stability of the thickness of the ceramic particles attached to the surface of the first cell, in the step of attaching ceramic particles to the surface of the first cells, the lower limit of the average flow velocity of the aerosol flowing inside the pillar-shaped honeycomb structure is preferably 5 m/s or more, and more preferably 8 m/s or more. Further, in order to maintain a high porosity of the porous film, the upper limit of the average flow velocity of the aerosol flowing through the pillar-shaped honeycomb structure is preferably 20 m/s or less, and preferably 15 m/s or less.

When the process of adhering ceramic particles to the surface of the first cells is continued, the pressure loss between the inlet side end surface and the outlet side end surface of the pillar-shaped honeycomb structure increases as the amount of adhered ceramic particles increases. Therefore, by determining the relationship between the amount of adhered ceramic particles and the pressure loss in advance, it is possible to determine the end point of the process of adhering the ceramic particles to the surface of the first cells based on the pressure loss. Therefore, the particle adhesion device 510 can be installed with a differential pressure gauge 550 to measure the pressure loss between the inlet side end surface 504 and the outlet side end surface 506 of the pillar-shaped honeycomb structure body 500, and the end point of the process may be determined based on the value of the differential pressure gauge.

A laser diffraction particle diameter distribution measuring device 519 may be installed inside the chamber 513. By installing the laser diffraction particle diameter distribution measuring device 519, the particle diameter distribution of ceramic particles in the aerosol injected from the aerosol generator 511 can be measured in real time. Thereby, it is possible to monitor whether ceramic particles having a desired particle diameter distribution are being supplied to the pillar-shaped honeycomb structure.

When performing the step of attaching ceramic particles to the surface of the first cells, since ceramic particles are adhered to the inlet side end surface 504 of the pillar-shaped honeycomb structure body 500, it is preferable to remove the ceramic particles by suction using a vacuum or the like while leveling the inlet side end surface with a jig such as a scraper.

### (Baking Treatment)

Thereafter, the ceramic particles adhered to the surface of the first cells are subjected to a baking treatment to generate a porous film composed of a plurality of particles on the surface of the first cells. In one embodiment, the baking process includes holding the pillar-shaped honeycomb structure having the ceramic particles adhered to the surface of the first cells in a heating furnace at an internal furnace atmosphere temperature of 1100 to 1300° C. for 1.5 to 4 hours. Baking at a temperature of 1100° C. or higher provides the advantage that the partition walls and the film material are fixed to each other. Further, by performing the baking treatment at 1300° C. or lower, there is an advantage that non-uniformity of the film due to unnecessary oxidation can be prevented. It is advantageous to set the holding time to 4 hours or less, since the longer the holding time is, the longer the interparticle distance of the plurality of particles constituting the porous film tends to become. On the other hand, if the holding time is too short, the porous film will easily peel off, so it is advantageous to set the holding time to 1.5 hours or more.

In the baking treatment, in order to increase the production rate, it is preferable that the average heating rate from room temperature (25° C.) to the maximum temperature is 100° C./Hr or more. Furthermore, in order to suppress the occurrence of cracks in the baking treatment, it is preferable that the average temperature rising rate from room temperature (25° C.) to the maximum temperature is 200° C./Hr or less. In addition, in order to suppress the occurrence of cracks and reduce the burden on the kiln materials, during the baking process, it is preferable that the average temperature decreasing rate from the maximum temperature to room temperature (25° C.) is to 200° C./Hr or less. In addition, in order to increase the production rate in the baking process, it is preferable that the average temperature decreasing rate from the maximum temperature to room temperature (25° C.) during cooling is 100° C./Hr or more.

In a preferred embodiment, the baking process includes holding the pillar-shaped honeycomb structure body having ceramic particles adhered to the surface of the first cells in a heating furnace with an internal furnace atmosphere temperature of 1100 to 1200° C. for 1.5 to 4 hours. In a more preferred embodiment, the baking process includes holding the pillar-shaped honeycomb structure body having ceramic particles adhered to the surface of the first cells in a heating furnace with an internal furnace atmosphere temperature of 1200° C. for 1.5 to 2.5 hours, even more preferably 2 to 2.5 hours.

The baking treatment can be carried out by placing the pillar-shaped honeycomb structure body to which the ceramic particles have been adhered, for example, in an electric furnace or a gas furnace. By the heat treatment, the ceramic particles are bonded to each other, and the ceramic particles are baked to the partition walls in the first cells, so that a porous film is formed on the surface of the first cells. When the heat treatment is performed under oxygen-containing conditions such as air, a surface oxide film is generated on the surfaces of the ceramic particles, and the bonding between the ceramic particles is promoted. This provides a porous film that is difficult to peel off.

### EXAMPLES

Hereinafter, examples will be illustrated to better understand the present invention and its advantages, but the present invention is not limited to the examples.

### Example 1

### (1) Manufacture of Pillar-Shaped Honeycomb Structure Body

To 100 parts by mass of a cordierite-forming raw material, 3 parts by mass of a pore-forming material, 55 parts by mass of a dispersion medium, 6 parts by mass of an organic binder, and 1 part by mass of dispersant were added, and they were mixed and kneaded, thereby obtaining a green body. Alumina, aluminum hydroxide, kaolin, talc, and silica were used as the cordierite-forming raw material. Water was used as the dispersion medium, a water-absorbing polymer was used as the pore-forming material, hydroxypropyl methyl cellulose was used as the organic binder, and fatty acid soap was used as the dispersant.

This green body was put into an extrusion molding machine and extruded through a die of a predetermined shape to obtain a cylindrical honeycomb formed body. After dielectrically drying and hot wind drying the obtained honeycomb formed body, both end surfaces were cut to a predetermined size to obtain a honeycomb dried body.

The obtained honeycomb dried body was sealed using cordierite such that first cells and second cells were arranged adjacent to each other alternately. Afterwards, it was heated and degreased at about 200° C. in the air atmosphere, and then fired at 1420° C. for 5 hours in the air atmosphere to obtain a pillar-shaped honeycomb structure body. In addition, a number of pillar-shaped honeycomb structure bodies required for the following tests was manufactured.

The specifications of the pillar-shaped honeycomb structure bodies are as follows.
Overall shape: cylindrical with diameter 132 mm×height 120 mm
Cell shape in cross-section perpendicular to cell flow path direction: square
Cell density (number of cells per unit cross-sectional area): 200 cpsi
Partition wall thickness: 8 mil (0.2 mm) (nominal value based on the specifications of the die)

### (2) Adhesion of Ceramic Particles to Pillar-Shaped Honeycomb Structure Body

For the pillar-shaped honeycomb structure body prepared above, using a particle adhesion device with the configuration shown in FIG. 5, an aerosol containing ceramic particles was injected toward the center of the inlet side end surface of the pillar-shaped honeycomb structure body in a direction perpendicular to the inlet side end surface, thereby causing the ceramic particles to adhere to the surface of the first cells. The specifications and operating conditions of the particle adhesion device were as follows.

### Chamber

Shape: Cylindrical
Inner diameter: 300 mm
Length: 600 mm
Ambient gas: Air
Opening position for taking in ambient gas: only the surface facing the inlet side end surface of the pillar-shaped honeycomb structure body
Filter installation at opening: Yes
Aerosol generator nozzle position: center of the facing surface
Structure of the facing surface: punching plate
(An insertion port for inserting the nozzle of the aerosol generator was provided in the center of the punching plate. Also, a disc-shaped plate with a diameter of 150 mm centered on the insertion port was fixed to form a closing portion)
Distance L from the nozzle outlet of the aerosol generator to the inlet side end surface of the pillar-shaped honeycomb structure body: 600 mm
Aerosol generator: In-house product with the structure shown in FIG. 4
Type: Continuous aerosol generator
Connection method of driving gas flow path and flow path for suction and conveyance: Venturi ejector
Installation location of the ceramic particle supply port:
downstream of the point where the flow path was most constricted in the venturi portion and adjacent to that point
Method of supplying ceramic particles to the accommodating section: screw feeder
Type of the accommodating section: Funnel
Type of ceramic particles accommodated in the accommodating section: SiC particles (commercially available)
BET specific surface area of ceramic particles accommodated in the accommodating section: see Table 1
(Measuring device: model Macsorb (registered trademark) HM model-1200 manufactured by Mauntech
Measurement method: BET single point method (JIS Z8830: 2013)
Gas used: Nitrogen
Pretreatment: degas the sample under vacuum at 110° C. for 2 hours.
Sample measurement amount: 1 g)
(Calculation method: a sample was placed in an adsorption cell, and by creating a vacuum inside the adsorption cell while heating, gas molecules adsorbed on the sample surface were removed, and the weight of the sample was measured. Thereafter, nitrogen gas was flowed into the adsorption cell in which the sample was enclosed. As a result, nitrogen was adsorbed on the sample surface, and by further increasing the amount of nitrogen gas flowing in, gas molecules form a plurality of layers on the sample surface. At this time, for the above process, a graph plotting the change in adsorption amount against the change in pressure was created, and from the graph obtained, the amount of gas molecules adsorbed only on the sample surface was determined using the BET adsorption isotherm equation. At this time, since the adsorption occupied area of nitrogen molecules was known in advance, the surface area of the sample can be determined based on the amount of gas molecules adsorbed.)
Volume-based particle diameter distribution of ceramic particles accommodated in the storage section (measured by laser diffraction/scattering method): median diameter (D50): see Table 1
Driving gas: compressed dry air (dew point 10° C. or less)
Ambient gas to be sucked: the air
Flow rate of driving gas immediately before it passed through the venturi portion: 26 m/s (measured by Anemo Master)
Ratio of the flow path cross-sectional area immediately before the venturi portion to the flow path cross-sectional area of the venturi portion=1:0.028
Average flow rate of aerosol injected from the nozzle: 120 L/min (measured with a flowmeter)
Aerosol generator nozzle inner diameter: 12 mm

### Operating Conditions

Blower suction flow rate: 4000 L/min
Average flow rate of aerosol flowing inside the chamber: 1 m/s (measured by Anemo Master)
Average flow rate of aerosol flowing inside the pillar-shaped honeycomb structure body: approximately 7 m/s (calculated from flow rate/cell opening area)

### (3) Baking Treatment

While the inlet side end surface of the pillar-shaped honeycomb structure body to which the ceramic particles were adhered was leveled with a scraper, the ceramic particles adhering to the inlet side end surface were removed by vacuum. Thereafter, the pillar-shaped honeycomb structure body was placed in an electric furnace and subjected to baking treatment in the air atmosphere under the conditions of baking temperature and holding time listed in Table 1, thereby forming a porous film on the surface of the first cells, and obtaining a pillar-shaped honeycomb structure body. During the baking process, the average temperature rising rate from room temperature (25° C.) to reach the maximum temperature when increasing the temperature was 150° C./Hr, and the average temperature decrease rate from the maximum temperature to reach room temperature (25° C.) when decreasing the temperature was 150° C./Hr. In addition, a number of pillar-shaped honeycomb structure filters required for carrying out the following property evaluation was prepared.

### Examples 2 to 8, Comparative Examples 1 to 4

A pillar-shaped honeycomb structure filter was manufactured under the same conditions as in Example 1, except that the BET specific surface area and median diameter (D50) of the ceramic particles accommodated in the accommodating section of the aerosol generator were changed to the conditions listed in Table 1, and the baking treatment was changed to the conditions listed in Table 1. Further, the average thickness of the porous film was set to 15 μm in all test examples by keeping the aerosol flow rate and injecting time constant. All of the ceramic particles used were commercially available products.

### <Porosity of Partition Walls>

When the porosity of the partition walls of the pillar-shaped honeycomb structure filters according to Examples 1 to 8 and Comparative Examples 1 to 4 obtained by the above manufacturing method was measured based on SEM images according to the measurement method described above, it was 59% for all the test examples. The device used for the measurement was FE-SEM (model: ULTRA55 (manufactured by ZEISS)). The image analysis software used was HALCON-version 11.0.5 from lynx Corporation. The results are shown in Table 1.

### <Porous Film Properties>

### (1) Average Film Thickness

The average film thickness of the porous film of the pillar-shaped honeycomb structure filters according to Examples 1 to 8 and Comparative Examples 1 to 4 obtained by the above manufacturing method was measured according to the measurement method described above, and it was 15 μm for all the test examples. The 3D shape measuring machine used for the measurement was VR-3200 manufactured by Keyence Corporation.

### (2) Interparticle Distance

Regarding the plurality of particles constituting the porous film of the pillar-shaped honeycomb structure filters according to Examples 1 to 8 and Comparative Examples 1 to 4 obtained by the above manufacturing method, the frequency distribution of the interparticle distance, which is the distance between adjacent particles in the direction perpendicular to the film thickness direction, was determined based on the SEM image according to the measurement method described above, and the interparticle distance (D90), the average value of the interparticle distance (Ave.), and the standard deviation of the interparticle distance (o) were calculated. The device used for the measurement was FE-SEM (model: ULTRA55 (manufactured by ZEISS)). The image analysis software used was HALCON-version 11.0.5 from lynx Corporation.

The results are shown in Table 1.

### <Filter Performance>

### (1) PM Collection Test

The following PM collection test was conducted on each of the pillar-shaped honeycomb structure filters according to Examples 1 to 8 and Comparative Examples 1 to 4 obtained by the above manufacturing method. An aerosol containing oil particles such as DEHS (bis (2-ethylhexyl) sebacate) particles with a particle diameter of approximately 100 to 1000 nm was injected from an aerosol generator and was supplied to the pillar-shaped honeycomb structure filter at a flow rate of 500 to 10,000 L/min for 30 seconds. The PM was collected by the pillar-shaped honeycomb structure filter, and PN (number of discharged particles) in the exhaust gas was measured using a PN counter at the inlet side (upstream side in the gas flow direction) and outlet side (downstream side in the gas flow direction) of the pillar-shaped honeycomb structure filter. The collection performance was calculated using the formula (number of particles on the inlet side−number of particles on the outlet side)/number of particles on the inlet side×100(%).

The results are shown in Table 1. Further, a graph showing the relationship between the interparticle distance (D90) and the collection performance is shown in FIG. 7.

TABLE 1

| | | Example 1 | Example 2 | Example 3 | Example 4 | Example 5 | Example 6 | Example 7 |
|---|---|---|---|---|---|---|---|---|
| Ceramic | Specific surface | 18.5 | 18.5 | 18.5 | 18.5 | 12.5 | 12.5 | 4.0 |
| particles | area [m²/g] | | | | | | | |
| | Median diameter | 1.0 | 1.0 | 1.0 | 1.0 | 1.0 | 1.0 | 2.5 |
| | D50 [μm] | | | | | | | |
| Baking | Baking temperature | 1100 | 1200 | 1300 | 1300 | 1100 | 1200 | 1100 |
| treatment | [° C.] | | | | | | | |
| conditions | Holding time [h] | 2 | 2 | 2 | 4 | 2 | 2 | 2 |
| Porous film | Average film | 15 | 15 | 15 | 15 | 15 | 15 | 15 |
| properties | thickness [μm] | | | | | | | |
| | Interparticle distance | 3.63 | 5.48 | 6.22 | 7.01 | 9.11 | 9.34 | 10.26 |
| | D90 [μm] | | | | | | | |
| | Interparticle | 2.04 | 2.93 | 3.24 | 3.41 | 3.22 | 3.77 | 4.36 |
| | distance Ave. [μm] | | | | | | | |
| | Interparticle | 1.36 | 1.73 | 1.95 | 2.11 | 3.35 | 3.55 | 3.36 |
| | distance σ [μm] | | | | | | | |
| Filter | Collection | 99.77 | 99.59 | 99.41 | 99.34 | 98.31 | 97.24 | 93.38 |
| performance | performance [%] | | | | | | | |

| | | | Comprative | Comprative | Comprative | Comprative |
|---|---|---|---|---|---|---|
| | | Example 8 | Example 1 | Example 2 | Example 3 | Example 4 |
| Ceramic | Specific surface | 4.0 | 3.0 | 3.0 | 2.6 | 2.6 |
| particles | area [m²/g] | | | | | |
| | Median diameter | 2.5 | 2.5 | 2.5 | 2.5 | 2.5 |
| | D50 [μm] | | | | | |
| Baking | Baking temperature | 1200 | 1300 | 1300 | 1100 | 1200 |
| treatment | [° C.] | | | | | |
| conditions | Holding time [h] | 2 | 2 | 4 | 2 | 2 |
| Porous film | Average film | 15 | 15 | 15 | 15 | 15 |
| properties | thickness [μm] | | | | | |
| | Interparticle distance | 11.60 | 14.21 | 15.38 | 13.51 | 13.73 |
| | D90 [μm] | | | | | |
| | Interparticle | 5.21 | 6.72 | 7.02 | 5.38 | 5.78 |
| | distance Ave. [μm] | | | | | |
| | Interparticle | 3.40 | 3.87 | 4.06 | 3.92 | 4.11 |
| | distance σ [μm] | | | | | |
| Filter | Collection | 89.61 | 73.80 | 71.92 | 82.28 | 77.44 |
| performance | performance [%] | | | | | |

### DESCRIPTION OF REFERENCE NUMERALS

100: Pillar-shaped honeycomb structure filter
102: Outer peripheral side wall
104: Inlet side end surface
106: Outlet side end surface
108: First cell
109: Sealing portion
110: Second cell
112: Partition wall
114: Porous film
400: Aerosol generator
401: Nozzle
402: Ceramic particles
403: Flow path
403e: Outlet
407: Driving gas flow path
407i: Supply port
407v: Venturi portion
409: Accommodating section
409e: Outlet
409i: Inlet
410: Venturi ejector
411: Powder metering feeder
500: Pillar-shaped honeycomb structure body
502: Outer peripheral side wall
504: Inlet side end surface
506: Outlet side end surface
510: Particle adhesion device
511: Aerosol generator
511a: Nozzle
512: Blower
513: Chamber
513a: Facing surface
513b: Insertion port
513c: Opening
513d: Side wall
513e: Downstream end
513f: Upstream end
513g: Filter
513h: Tapered portion
514: Holder
514a: Housing
514b: Chuck mechanism
514e: Exhaust port
515: Exhaust pipe
516: Flow meter
518: Closing portion
519: Laser diffraction particle diameter distribution measuring device
550: Differential pressure gauge

1. A pillar-shaped honeycomb structure filter, comprising a plurality of first cells extending from an inlet side end surface to an outlet side end surface, opening on the inlet side end surface and having a sealing portion on the outlet side end surface; and a plurality of second cells extending from the inlet side end surface to the outlet side end surface, having a sealing portion on the inlet side end surface and opening on the outlet side end surface, the plurality of first cells and the plurality of second cells alternately arranged adjacent to each other with a porous partition wall interposed therebetween;
wherein a porous film composed of a plurality of particles is formed on a surface of each of the first cells, and
when observing the porous film in a cross-section parallel to a film thickness direction, and measuring an interparticle distance for the plurality of particles, which is a distance between adjacent particles in a direction perpendicular to the film thickness direction to determine a frequency distribution of the interparticle distance, the interparticle distance at which a cumulative ratio is 90% (D90) is 12.0 μm or less.

2. The pillar-shaped honeycomb structure filter according to claim 1, wherein the interparticle distance (D90) at which the cumulative ratio is 90% is 11.0 μm or less.

3. The pillar-shaped honeycomb structure filter according to claim 1, wherein when observing the porous film in the cross-section parallel to the film thickness direction, and measuring the interparticle distance for the plurality of particles, which is the distance between adjacent particles in the direction perpendicular to the film thickness direction to determine the frequency distribution of the interparticle distance, an average value of the interparticle distance is 5.3 μm or less.

4. The pillar-shaped honeycomb structure filter according to claim 3, wherein the average value of the interparticle distance is 5.0 μm or less.

5. The pillar-shaped honeycomb structure filter according to claim 1, wherein when observing the porous film in the cross-section parallel to the film thickness direction, and measuring the interparticle distance for the plurality of particles, which is the distance between adjacent particles in the direction perpendicular to the film thickness direction to determine the frequency distribution of the interparticle distance, a standard deviation of the interparticle distance is 3.6 μm or less.

6. The pillar-shaped honeycomb structure filter according to claim 5, wherein the standard deviation of the interparticle distance is 3.4 μm or less.

7. The pillar-shaped honeycomb structure filter according to claim 1, wherein the porous film has an average thickness of 2 to 40 μm.

8. The pillar-shaped honeycomb structure filter according to claim 1, wherein a main component of the porous film is silicon carbide, alumina, silica, cordierite, or mullite.

9. A method for manufacturing a pillar-shaped honeycomb structure filter, comprising:
preparing a pillar-shaped honeycomb structure body, comprising a plurality of first cells extending from an inlet side end surface to an outlet side end surface, opening on the inlet side end surface and having a sealing portion on the outlet side end surface; and a plurality of second cells extending from the inlet side end surface to the outlet side end surface, having a sealing portion on the inlet side end surface and opening on the outlet side end surface, the plurality of first cells and the plurality of second cells alternately arranged adjacent to each other with a porous partition wall interposed therebetween;
adhering ceramic particles to a surface of the first cells by injecting an aerosol containing ceramic particles from a nozzle of an aerosol generator toward the inlet side end surface from a direction perpendicular to the inlet side end surface, while applying a suction force to the outlet side end surface to suck the injected aerosol from the inlet side end surface; and
performing a baking treatment on the ceramic particles adhered to the surface of the first cells to generate a porous film composed of a plurality of particles on the surface of the first cells;
wherein the aerosol generator has an accommodating section that accommodates the ceramic particles having a BET specific surface area of 3.5 m²/g or more, and the ceramic particles are configured to be supplied from the accommodating section to the nozzle.

10. The method for manufacturing a pillar-shaped honeycomb structure filter according to claim 9, wherein the accommodating section accommodates the ceramic particles having a BET specific surface area of 4.0 m²/g or more.

11. The method for manufacturing a pillar-shaped honeycomb structure filter according to claim 9, wherein the aerosol generator comprises a driving gas flow path for flowing pressurized driving gas; a supply port provided on the way of the driving gas flow path and capable of sucking the ceramic particles from the accommodating section, from an outer peripheral side of the driving gas flow path into the driving gas flow path; and the nozzle that is attached to a tip of the driving gas flow path and is capable of injecting the aerosol.

12. The method for manufacturing a pillar-shaped honeycomb structure filter according to claim 9, wherein the accommodation section accommodates the ceramic particles having a median diameter (D50) of 0.5 to 3.0 μm in a volume-based cumulative particle diameter distribution measured by a laser diffraction/scattering method.

13. The method for manufacturing a pillar-shaped honeycomb structure filter according to claim 9, wherein the baking treatment comprises holding the pillar-shaped honeycomb structure body having the ceramic particles adhered to the surface of the first cells in a heating furnace with an internal furnace atmosphere temperature of 1100 to 1300° C. for 1.5 to 4 hours.
